(19) United States
(12) Patent Application Publication
(10) Pub. No.: US 2002/0035527 A1
(43) Pub. Date: Mar. 21, 2002

(54) System for relating investment account information to an investment objective

(76) Inventor: William R. Corrin, Long Beach, CA (US)

Correspondence Address: THOMAS B. LUEBBERING, HOVEY, WILLIAMS, TIMMONS & COLLINS, SUITE 400, 2405 GRAND BLVD., KANSAS CITY, MO, 64108, US

(21) Appl. No.: 09/836,833

(22) Filed: Apr. 17, 2001

Related U.S. Application Data
(60) Provisional application No. 60/197,455, filed on Apr. 17, 2000.

(51) Int. Cl. G06F 17/60

(52) U.S. Cl. 705/35

(57) ABSTRACT

A computer-implemented method, computer program, and Internet web site that provides key investment and planning tools for use by individuals in planning their retirement. The invention provides investors with a complete account analysis and investment advisory report that quantifies meaningful saving goals, determines the effectiveness of the investor's current strategy, establishes investment performance expectations, offers investment guidance, and monitors and reevaluates their progress. Through a form of artificial intelligence, the invention brings the same sophisticated investment analysis techniques used by large pension plans and money managers to the individual investor, allowing him to interpret account statement information from current and previous periods and easily relate it to two quantifiable goals.

### RELATED APPLICATION

The present application relates to and claims priority with regard to all common subject matter of provisional patent application titled “SYSTEM FOR RELATING INVESTMENT ACCOUNT INFORMATION TO AN INVESTMENT OBJECTIVE,” Ser. No. 60/197,455, filed Apr. 17, 2000. The identified provisional patent application is hereby incorporated into the present application by reference.

### FIELD OF THE INVENTION

The present invention relates to a method and apparatus for planning and attaining retirement income goals. More particularly, the invention relates to a computer-implemented method, computer program, and Internet web site that may be accessed by individuals for setting retirement goals, investment strategy planning, progress tracking, and attaining investment and savings funds sufficient to retire in a manner desired by the individual.

### BACKGROUND

More investors would attain a successful retirement if they established quantifiable goals and could effectively relate their present account statement information to incremental benchmarks leading to the reaching of their goals. Currently investors lack tools that can determine performance expectations for their investment strategy and compare their account's actual performance to those expectations. With this information, investors could better measure their incremental progress toward their long-term goal and make required changes to assure proper management of their account and attainment of a successful retirement.

Investment account statements contain transactional data for short periods of time, typically calendar quarters, which is out of context vis-a-vis an investor's long-term objective. Investors need a way to transform short-term transactional data from many prior periods into useful investment knowledge that they can apply in managing their account on an ongoing basis.

Investors who use payroll reduction qualified savings plans to save for retirement are typically passive and don't want to learn the technicalities of investing. Rather, they want someone to tell them how to invest so that they will enjoy a comfortable and secure retirement. Brokers, advisors, and investment software offer plenty of advice, but no means of tracking its efficacy because they don't provide incremental benchmarks for measuring the investor's progress toward a long-term goal and rarely have continuous access to historical account data.

Lastly, most investors do not want to be bothered with entering volumes of data into a software program or web site. Moreover, they are uncomfortable making key assumptions regarding interest rates, inflation rates, tax brackets, future spending patterns, etc. Because of this, available retirement planning and investment advice software programs are grossly underutilized or, worse, the results are incorrect and misleading.

Advisors are typically paid a fee or earn commission for providing investment advice. Most small to medium investors do not generate a sufficient commission or cannot afford to pay the fees for a competent professional advisor and therefore usually lack crucial investment advice in their efforts to manage a long-term saving plan.

Employees typically do not receive any type of personalized counsel until they enroll in a plan. This increases the likelihood that many employees will not begin saving as soon as they should, diminishing the likelihood of achieving a comfortable retirement.

### SUMMARY OF THE INVENTION

The present invention solves the above-described problems and provides a distinct advance in the art of the investment and retirement planning for individuals. More particularly, the present invention comprises a computer-implemented method, computer program, and Internet web site that provides key investment and planning tools for use by individuals in planning their retirement.

The method of one embodiment of the present invention is preferably implemented with the distribution of printed reports to all participants and with an Internet web site that may be accessed by investors that enables them to change basic assumptions and add additional data regarding other investments that are being held in anticipation of generating retirement income. The system provides investors with a complete account analysis and investment advisory report that quantifies meaningful saving goals, determines the effectiveness of the investor's current strategy, establishes investment performance expectations, offers investment guidance, and monitors and reevaluates their progress. Through a form of artificial intelligence, the invention brings the same sophisticated investment analysis techniques used by large pension plans and money managers to the individual investor, allowing him to interpret account statement information from current and previous periods and easily relate it to two quantifiable goals.

In one embodiment, the invention is implemented using stand-alone software and provides investors with a complete account analysis and investment advisory report that quantifies meaningful saving goals, determines the effectiveness of the investor's current strategy, establishes investment performance expectations, offers investment guidance, and monitors and reevaluates their progress. Through a form of artificial intelligence, the invention brings the same sophisticated investment analysis techniques used by large pension plans and money managers to the individual investor, allowing him to interpret account statement information from current and previous periods and easily relate it to two quantifiable goals.

In another embodiment of the present invention, the invention provides all of its benefits without requiring investor input. The method broadly includes gathering data from employers and record keepers, calculating key assumptions such as rates of return and risk based on current and potential investment strategies, and displaying established goal information, current investment and savings strategy information, interim benchmark information, and short-term and long-term results information. In one embodiment investors can change variables such as retirement age, an amount to be left to beneficiaries, specific loan repayment information, expected salary of final job position, and information about other investments.

One embodiment of the invention includes graphical illustrations and text that transform large amounts of data into a visual report displaying goals, strategies, progress benchmarks, and performance measurement. By referring to the investor's account analysis at least once each year, an investor can reevaluate and modify investment and savings strategies in the face of life's changes to improve retirement income.

These and other important aspects of the present invention are described more fully in the detailed description below.

### BRIEF DESCRIPTION OF THE DRAWINGS

A preferred embodiment of the present invention is described in detail below with reference to the attached drawing figures, wherein:

FIG. 1 is a schematic diagram of computer equipment that may be used to implement certain aspects of the present invention;

FIG. 2 is an example of a report provided to participants of a retirement plan with historical participant data that utilizes one embodiment of the invention;

FIG. 3 is an example of a report provided to participants of a retirement plan without historical participant data that utilizes one embodiment of the invention;

FIG. 4 is an example of a report provided to non-participants of a retirement plan that utilizes one embodiment of the invention

FIG. 5 is a schematic of the processes that are used to generate the text and illustrations of FIG. 2.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following description of the invention primarily addresses the needs of investors in long-term, payroll deduction savings plans such as 401(k) plans, government deferred compensation plans (IRC §457), Tax Deferred Annuity plans (§403(b)), Individual Retirement Arrangements (IRAs), and similar arrangements available under foreign tax codes. However, the invention can be used by all long-term, pre-tax or after-tax investors.

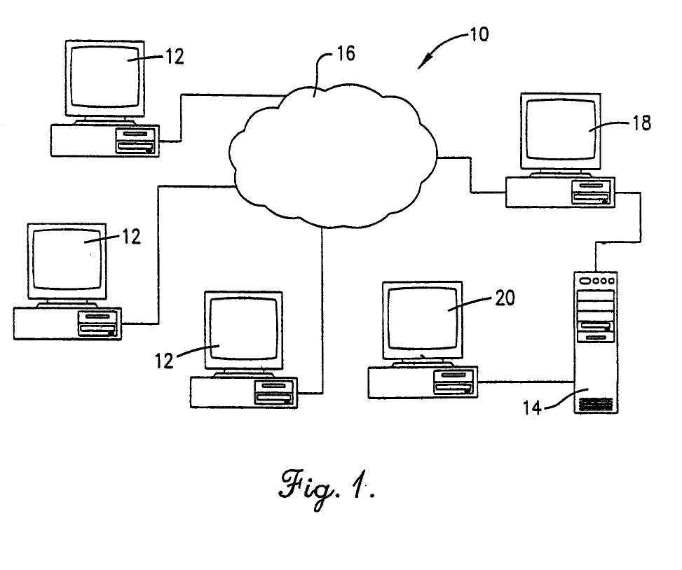

The computer program and method of the present invention are preferably implemented with computer equipment such as the equipment broadly referred to by the numeral 10 in FIG. 1. In one embodiment, the computer equipment includes a plurality of computers 12 and a host computer 14 coupled together via a communications network 16. The computer equipment described and illustrated herein may be replaced with other conventional computer equipment and web access devices without departing from the scope of the invention.

In one embodiment, the computers 12 are used by investors wishing to establish investment goals and revise those goals in light of life changing events. The computers 12 may be located anywhere such as in the offices or homes of the investors, or carried by investors using laptop computers, personal digital assistants, cell phones, and other web access devices. Each computer 12 preferably includes an Internet connection and a web browser that permits access to the Internet via the communications network 16.

In another embodiment, investors may enjoy the benefits of the invention without directly accessing a computer. In this embodiment, investors who are members of a plan serviced by the invention receive periodic, preferably quarterly, printed reports that advise them of current account performance and strategies as further described below. These reports are created by a computer, such as host computer 14, but may be crated by any computer capable of running the program of the invention whether connected to a communications network or not.

Turning now to FIG. 2, an example of a report prepared by the present invention for an investor for whom historical cash flow data is available to the computer program is depicted. This embodiment of the invention uses a three-step format, Evaluation, Adjustment, and Measurement, that puts investors on a path to an established retirement goal and keeps them there. In a preferred embodiment of the invention, the calculations are carried out by commercially available software sold under the name Microsoft Excel, a spreadsheet database application. References below to cells, rows, and columns are to cells, rows, and columns within a spreadsheet. The formulas described below are set forth in a format required by Excel to obtain the desired calculations and displays as will be understood by one of ordinary skill in the art.

Evaluation of the Current Strategy

The first part of the report evaluates the investor's current saving and investment strategy in three sections. The first section establishes the retirement income goals 101 to be attained, the second shows the investor where his account balance should be today 102 based on his current strategy and the last 103 develops return expectations for his current strategy. As used in this description, strategy refers to the interplay of three variables, length of years until retirement, amount of income saved for retirement, and amount of risk and return on investments. Alteration of any or all of these variables in the retirement planning of the investor constitutes a different strategy.

The assumptions being used are outlined in the opening remarks 104 which explain the primary factors that determine the investor's retirement income: current account balance (if any), deferral and match contributions, his retirement date and expected growth of his investments.

In the Retirement Income Goals illustration 101, this embodiment of the invention calculates the combined income from Social Security and/or the defined benefit pension plan and the defined contribution plan and displays the result 105. The program compares this calculation to two attainable retirement income goals, one is 100% of projected inflation adjusted ending salary 106, the other 107 is typically a smaller percentage of projected inflation adjusted ending salary, e.g. 80%. Since people can easily relate anticipated expenses to their current income, these are easily definable, relevant and understandable goals.

The text of section 101 tells the investor the benefits that Social Security and/or the defined benefit plan would provide as a dollar figure and as a percentage of retirement income. It also tells him the benefits that the defined contribution plan would provide if he stays the course with his current strategy as a dollar figure and as a percentage of ending retirement income.

Information that is entered or calculated for this illustration includes:

Inflation estimate

Current salary

Deferral percentage

Match percentage

Expected rate of return of the existing portfolio

100% Goal equal to the value of ending salary

Other goal equal to the value of a lesser percentage of ending salary

Social Security benefits at retirement

Defined Benefit plan benefits at retirement

Working Years

Age payments cease

Account Value to be left to an estate

Future value of current saving strategy at retirement

Income provided by current strategy at retirement

Total income at retirement

Cash flows for IRAs and other outside investments

Repayments of outstanding plan loans

The plan sponsor or his financial consultant choose the default assumptions. The inflation estimate typically ranges between 2% and 5%, current salary and deferral percentage come from Census data, and the Match information comes from the Plan data.

The expected rate of return is calculated using the asset allocation of the participant's existing account balance using Asset Allocation Data.

The 100% goal 106 is the future value of the investor's current salary after considering the inflation estimate, merit increases and the number of years until retirement. The other goal is typically the 100% goal multiplied by a lower income replacement percentage or “other goal”, which can be either a default value or entered by the participant in an interactive version.

The amount of Social Security income is calculated using the ANYPIA program that is available from the Social Security Administration. Other defined benefit retirement plans such as Public Employees Retirement Systems are calculated using their formulas, which are typically based on the average of the last few years of ending salary and years of service.

Social Security benefits at retirement are calculated by dividing the Social Security benefits that would be provided by the investor's current salary as though he retired today by his current salary to get a percentage of income replacement from Social Security. This replacement percentage is applied to the projected ending salary to determine the dollar amount of Social Security benefits at retirement. This calculation assumes that Social Security and salary will keep in step with inflation.

The number of Working Years is the number of years that the investor has to work until normal Social Security retirement age. It is calculated as the expected retirement date less the current date. (In these examples we will use 17 years.)

Income Provided by the Current Strategy at retirement is calculated in a multi-step process. First, the program includes a series of spreadsheet columns called “Accumulation Period” that determine the future value of the current strategy at retirement, then columns called “Retirement Income from Projected Account Value” interpolate the amount of retirement income provided from this future value.

Within “Accumulation Period”, the “Salary” column calculates each year's inflation adjusted salary beginning with the current salary, which is increased by the estimated rate of inflation and other estimated pay increases for each succeeding year.

An example of a Salary spreadsheet column formula is:

=IF(AA5>Working_years,AB4*(1+Inflation_Est),AB4*(1+Inflation_Est+A140))

Where inflation only is applied after normal Social Security retirement age

A140 determines the amount of increase to apply during the working years.

A “Deferrals” column calculates the future deferral amounts for each year by multiplying the inflation-adjusted salary for each year by the current deferral percentage. The “Match” column calculates future match amounts for each year by multiplying the inflation-adjusted salary for each year by the current match percentage calculated in the table, which uses the matching formula limitations. The “Match Calculation” column determines the match percentage and the dollar amount of the match. The value in is tested to determine whether it exceeds the maximum dollar amount of matching contributions.

The “FV Deferrals” and “FV Match” columns calculate the future value of the deferral and match accounts for each year. They use the expected rate of return of the investor's current portfolio, the number of pay periods each year, each year's corresponding deferral in and loan repayment or match contributions respectively, and the previous year's ending value as the beginning value.

An example of a FV Deferral calculation in a spreadsheet is:

=FV(IF(Contrib_Pct=0,Max_Non_part_Return,Exp_ROR)/Pay_Periods,Pay_Periods,−(AC13+GA13)/Pay_Periods,−AD12)

Where the rate of return is either a maximum rate for non-participants or the actual expected rate of return for participants.

The values in column GA (GA13 in this case) are loan repayments for each year.

An example of a FV Match calculation in a spreadsheet is:

=FV(IF(Contrib_Pct=0,Max_Non_part_Return,Exp_ROR)/Pay_Periods,Pay_Periods,−AE13/Pay_Periods,−AF12)

Where the rate of return is either a maximum rate for non-participants or the actual expected rate of return for participants.

The future value that corresponds to the number of working years is chosen as the projected account balance at retirement. Technically, the value for each year represents the account value as of the last day of that year, so the value for the year chosen for the last working year is the value on the last day of work, or value at retirement. For example, working years in this example equal 17, so the projected account balance at retirement would be the sum of the FV Deferral and FV Match amounts plus the FV of all outside investments.

Next, a Retirement Income from the Projected Account Value table interpolates the amount of retirement income provided from the projected account balance at retirement using “Payment” and “Present Value Payment” columns. This process tries different beginning values to generate inflation adjusted retirement income for each year, then calculates the present value of that income stream beginning with the year that payments are scheduled to stop and the value that is to be left in the account. When the present value of the retirement income stream for the year of retirement equals the ending value at retirement calculated by the Accumulation Period table above, the interpolated value is the income generated by the projected value at retirement for the current strategy.

The Payment column calculates values that represent the inflation-adjusted retirement income for each year in retirement starting with the amount that is being interpolated. Each year's value is the previous year's value increased by the inflation rate.

An example of a Payment column calculation is:

AQ4*(1+Inflation_{—Est)}

The “Present Value Payment” column calculates the present value at retirement of those amounts. It does this by calculating the present value of each year starting with a value of zero or an amount to be left to an estate in the final year as the starting point in the year that corresponds to the year in which the ending value occurs. (In these examples age 95 is be used as the age payments cease.) Each year's calculation uses the expected rate of return in retirement (expected rate of return less an amount to compensate for a more conservative portfolio), twelve monthly payments per year, payment amounts from the corresponding year in the Payment column and the next year's beginning value as the future value.

An example of a Present Value Payment formula is:

PV((Exp_ROR−AJ20)/12),12,−AQ15/12,−AR16)

Where cell AJ20 contains the amount of reduction during retirement.

An interpolation process calculates the retirement income stream in the Payment column that causes its value in the first year of the Present Value Payment column to be roughly equal to the projected account balance at retirement. The income stream in the Payment column is the income that can be expected each year from the account value at retirement.

Note that the value of the projected account balance at retirement is at the end of the year and the present value of the retirement income is as of the beginning of the year. In this example, it follows that the ending balance for the last year of saving accumulations, Working Years=17, equals the beginning balance for the first year of retirement income distributions, Years=18.

A macro processes the interpolation of the Retirement Income from the Plan. The interpolation process begins with an initial increment of $100,000, then increases in increments of $100,000 until its present value at retirement exceeds the future account value. At that point, one-half of the initial increment, $50,000, is added to the preceding value until the present value exceeds the future value. Then one one-tenth of initial increment, $10,000, is added to the preceding value until the present value exceeds the future value. The iteration process continues to compare the two values until the two values are equivalent, and the interpolated value is accurate to one dollar.

The total projected income for the current strategy 105 is the sum of the amount of Income From Projected Account Value, Social Security and/or defined benefits and income received from IRAs and other savings accounts.

The Retirement Track

The “Retirement Track” 109 illustrates the values of previous account balances in relation to the balances required at those times if the investor's existing saving strategy was to attain either of the goals. In the illustration, account balances are shown as a stacked bar graph 110 consisting of plan account balance 110a and employer contribution balance 110b and the required values of the goals are lines 111 that represent each goal's present values for each period.

Data Needed for the “Retirement Track”

Contribution and Match account balances

Social Security and/or defined benefits by year

Benefits required from the defined contribution plan

Account value in the final year (end of payments)

Account Balance needed at retirement

Account Balance needed as of the report date

Contribution and Match account balances 110 are obtained from the Values data. The required values of the goals 111 are each goal's present values for each period as calculated below.

Calculating the Values of the Goals

Determining the value that the investor should have in his account for each period is a multi-step process. First, the amount of money needed at retirement to pay each goal's income stream is determined by the Distribution Period table. The required amounts are the present value of the amount needed to pay the inflation adjusted retirement benefits until the final year (age 95 in this example).

In a similar fashion to the Salary column described above, the Retirement Income column calculates the annually inflation-adjusted retirement income for each year of retirement. It begins with the inflation adjusted income for the year after retirement as the beginning value and increases its value each year by the inflation estimate (merit pay increases are no longer a factor during retirement).

The “FV Social Security” column calculates the inflation-adjusted value of normal Social Security and/or defined benefit plan benefits for each year in retirement by increasing each successive year by the inflation estimate.

An example of a Future Value SS formula is:

AK12*(1+Inflation_Est)

Where AK12 is the retirement income for the previous year.

An “Income 100” column calculates the amount of benefits required from the defined contribution plan to pay 100% of ending salary each year (hereinafter referred to as “Inc 100”). The amount to be supplied each year for the 100% goal is the difference between the inflation adjusted retirement benefit in the “Retirement Income” column and the amount in the “FV Social Security” column plus withdrawals from outside investments.

The amount to be supplied for the other goal, (hereinafter referred to as “Other Goal”), is in the “Other Income” column. It is the difference between the amount in the “Retirement Income” column multiplied by the other income replacement percentage less the amount in the “FV Social Security” column plus withdrawals from outside investments.

An example of a calculation in the Other Income column is:

AJ4*Ent_Other_Goal-AK13-EV13

Where AJ4 is total retirement income, AK13 is Social Security income and EV13 is the total withdrawal from other investments for the year.

When Inc 100 and Other Inc are calculated, “PV Goal 100” and “PV Goal Other” columns are used to calculate the account balance that will be needed at retirement for the income streams in Inc 100 and Other Inc. Each cell in columns PV 100 and PV Other calculates the present value of the retirement benefits for each year the same way as explained in Retirement Income from Plan above, except that values are not interpolated. The ending estate value or zero is entered into the column in the cell that corresponds with the year for the age retirement income payments will end. The present value calculation for each year considers the expected rate of return in retirement (expected rate of return less a reduction factor, twelve monthly payments, the income needed each year from the defined contribution plan from either the Inc 100 or Other Inc columns and the subsequent year's beginning value as its future value.

An example of a PV Goal 100 formula is:

=IF(Years_in_Ret+Working_Years+1=AI15,B113,

PV(IF((Exp_ROR-AJ205)/12<Guar_ROR/12,Guar_ROR/12,(Exp_ROR_AJ205)/12), 12,−AL15/12,−AM16))

An example of a PV Other Goal formula is:

=IF(Years_in_Ret+Working_Years+1=AI15,B113,

PV(IF((Exp_ROR-AJ205)<Guar_ROR,Guar_ROR/12,(Exp_ROR-AJ205)/12), 12,-AN15/12,-AO16))

In both calculations, the statement:

IF(Years_in_Ret+Working_Years+1=AI15,B113), selects the cell to enter the inflation adjusted value of the ending estate value contained in cell B113.

AJ205 contains the reduction in the expected return during retirement.

The statement: IF((Exp_ROR-AJ205)/ 12<Guar_ROR/12,Guar_ROR/12,(Exp_ROR−AJ205)/12), tests to determine whether the reduced rate of return is less than the guaranteed rate. If it is, the guaranteed rate is used.

The values that correspond to the first year of retirement equals the Account Balance Needed at Retirement to earn 100% of ending salary or the other goal.

Once the Account Balances Needed at Retirement are determined, the “PV Goal 100” and “PV Other Goal” columns in the Accumulation Period table calculate the account balance needed as of the report date. They do this by calculating the present value for each working year beginning with the last working year in a similar manner to the PV calculations explained above.

The formulas use the expected rate of return, number of pay periods, inflation-adjusted deferrals and match and the values in Goal 100 and Other Goal as the beginning present values.

An example of a PV Goal 100 formula is:

=IF(Working_Years+1=AA21,AM4,

PV(Exp_ROR/Pay_Periods,Pay_Periods,(AC21+AE21)/Pay_Periods,-AG22))

Where the statement: IF(Working_Years+1=AA21,AM4), inserts the value in AM4 in the year after retirement.

An example of a PV Other Goal formula is:

=IF(Working_Years+1=AA21,AO4,

PV(Exp_ROR/Pay_Periods,Pay_Periods,(AC21+AE21)/Pay_Periods,-AH22))

The statement: IF(Working_Years+1=AA21,AO4), inserts the value in AO4 in the year after retirement.

The account balance needed as of the report date is the value that corresponds to the current year in the PV Goal 100 column and the PV Other Goal column.

The “Retirement Track” table uses each goal's account balance needed as of the report date to calculate required periodic (i.e. quarterly, semi-annual, etc.) account balances that correspond to the statement frequency. This table begins with the account balances needed as of the report date and copies them into a mid point row. It then calculates present values for periods prior to the current date and after the current date in the Goal 100 column and the Other Goal column in a similar manner as explained above. The Contribs column calculates inflation-adjusted contributions for the appropriate periods (quarterly, semi-annual or annual) before and after the current date.

An example of a Goal 100 formula is:

=PV(Exp_ROR/Pay_Periods,Pay_Periods/Report_Freq,W17/Pay_Periods,-Y18)

The report frequency determines the selection of the contribution amounts.

An example of a Contribs formula is:

=IF(D205=“Quarterly”,PV(Inflation_Est, 1,,-W19),

IF(D205=“Semi-annual”,PV(Inflation_Est,1,,-W19),PV(Inflation_Est, 1,,-W18)))

Where cell D205 contains the report frequency interval.

The data from the Retirement Track column to be presented in the Retirement Track chart 109 is selected in the Retirement Track Chart table. A row labeled “Count Periods” establishes the periods to be included in the chart. It begins by counting the number of periods for which data has been reported in Values Data and establishes the first reported account value as the starting point for the chart. Each additional period is listed across the top of the table. The present values for the two goals are extracted from the goal 100 and Other Goal columns in the Retirement Track table using a Lookup function that selects the data that corresponds to each period number. The data for the deferral and match account balances is taken from the Values Data table.

The Retirement Track chart 109 is interpreted the following way: If the height of the bars is increasing faster than the required value lines, it shows that the investor's account is growing faster than expected. The opposite is true if the heights of the bars are diverging below the lines. If the investor's account is on target to meet one of the goals, it should oscillate slightly above the line in rising markets and slightly below in declining markets.

Text 102 tells the investor the dollar values of both goals 111,112 at retirement age and explains how to interpret the illustration.

The illustration of the Retirement Track 109, shows the heights of the bars below the line that represents the required value to attain his 80% goal. If the advice from either “Choice 1” or “Choice 2” is chosen, the 80% goal line will then touch the top of the last bar. As long as the participant's expected return is calculated using the weights of his “Existing Account” allocation and the same long-term expected return benchmarks for each asset class, the goal line will remain the same.

Circumstances that would change the participant's expected return slightly would be a change in the asset weighting of his portfolio during markets where particular asset classes grew disproportionately to the others. In this case, the report alerts the participant to “rebalance” his “existing account” portfolio to match his “new contributions” portfolio if the variance in standard deviation between the new contribution portfolio and the existing account portfolio exceeds a predetermined value.

Developing Return Expectations

The program calculates the investor's expected long-term rates of return 113, 115 and ranges of one-year returns 114, 116 for his current contribution and his existing account allocations respectively. This helps him develop expectations for the actual short and long-term returns that his account might produce in the future. It uses pie charts to illustrate the New Contributions allocation 117 and Existing Account allocation 118, so the investor can visually compare how assets have grown or diminished compared to the way they were invested.

The Expected Returns table calculates the Expected Returns and Standard Deviations of the New Contribution and Existing Account Portfolios. The calculation for expected return is:

$$E ( {R}_{p} ) = {\sum }_{i = 1}^{n} {W}_{i} E ( {R}_{i} )$$

Where:

E(Rₚ)=the expected return on the portfolio

Wi=the proportion of funds placed in security i

E(Rᵢ)=the expected return on security i

n=number of securities

Simply put, the expected return is the sum of the weighted expected returns of the assets in the portfolio.

In order to calculate the expected returns, the weights of each asset and its expected return must be known. The weights for the New Contributions and Existing Account are calculated using data from the Asset Allocation data which is supplied by the plan administrator. The weights for each asset are calculated as the value for the asset divided by the sum of all of the assets.

The expected return on each asset calculation uses the asset class numbers in the Asset Allocation Data to chose the values from the Compound Return table that holds assumptions for long term rates of return for each asset class.

An example of the formula that calculates the expected return for six assets is:

(C427*C428)+(D427*D428)+(E427*E428)+(F427*F428) +(G427*G428)+(H427*H428)=0.1181 or 11.81%

Where the values in row 427 are each assets' weight and the values in row 428 are the expected return for each asset.

The risk (standard deviation) of the portfolios is calculated as follows:

$$\underline{SD ( {R}_{p} ) = {[ {\sum }_{x = 1}^{n} {W}_{x}^{2} VAR ( {R}_{x} ) + {\sum }_{x = 1}^{n} {\sum }_{y = 1}^{n} {W}_{x} {W}_{y} COV ( {R}_{x} {R}_{y} ) ]}^{1 / 2}}$$

Where:

VAR(Rₚ)=variance of the return of the portfolio

VAR(Rₓ)=the variance of return on security x

COV(Rₓ,R_{y})=the covariance between the returns for x and y

W=is the weight

Double summation=n² numbers are to be added together (i.e. all possible pairs of values for x and y.

Due to the complexity of this calculation, it is taken in several steps. First, a table calculates the covariance between all combinations of two assets. This table arranges all of the possible pairs of assets in the participant's portfolio. The asset class number of the first asset and the asset class number of the second asset are located on opposing axis. The covariance formula uses the asset class numbers to determine the two assets' correlation coefficient from the correlation coefficient table. The assets' weights and standard deviations are used in the formula.

Each cell in the table contains the formula:

=2*(Wₓ)*(W_{y})*(SDₓ)*(SD_{y})*(correlation coefficient of x,y)

For example, a covariance formula is:

=2*(C423)*(E423)*(C425)*(E425)*(INDEX(F412:M419,AL349,AL350))

Or 2*0.20*0.10*0.353*0.209*0.76=0.0022444

Where the cells in row 423 are the asset's weights and the cells in row 425 are the standard deviations. The LOOKUP function selects the correlation coefficient for the two assets as 0.76.

The portfolio standard deviation table calculates the standard deviation of the portfolio. An example of the formula that calculates the standard deviation for a portfolio with four assets is below.

(C427ˆ 2*C429ˆ 2+D427ˆ 2*D429ˆ 2+E427ˆ 2*E429ˆ 2+SUM(X411,Y411:Y413,Z411: Z415))ˆ 0.5

Where the square root of (Ww²*SDw²+Wx²*SDx²+Wy²*SDy²+Wz²*SDz²+(sum of the covariances of (w,x),(w,y),(w,z),(x,y),(x,z),(y,z))

The table calculates standard deviations for any number of assets, however the correct value is chosen using the count of the number of assets that are in the portfolio

The Second Step: Alternative Investment Strategies

If the investor's current strategy will not meet one of the goals (i.e. the account balance at retirement is less than either goal), the alternative investment strategies section provides two solutions that will enable the investor to meet the next goal. Adjustments to any of the three possible variables, expected rate of return, amount of investment and time until retirement, create suggestions for changes in his strategy.

If the account value at retirement is greater than the required value at retirement, a congratulatory message is given. It includes an estimate of the investor's retirement income, his estimated income if inflation is x% greater than the estimated inflation rate and the earliest year he could retire with income equal to his ending salary including Social Security and/or defined benefits.

If the investor's current strategy will not meet one of the goals, the following inputs are entered or calculated to create the solutions:

Current Deferral and Match Percentage

Expected Rate of Return=the rate of return of the existing strategy.

Required Rate of Return=the rate of return required to solve the equation

Maximum Payment=the total allowable investment and match in dollars

Required Payment=the total allowable investment required to achieve the solution

Current Account Value=total value of investment and match accounts

Goal=the present value of the retirement income stream

Working Years=number of years until normal Social Security retirement age

Years in Retirement=number of years from retirement date until payments are expected to end.

The Accumulation Period table determines the value of the investor's current strategy at retirement and the Distribution Period column determines the account balance that will be required at retirement to pay benefits equal to the two goals if the current strategy's rate of return is maintained. If there is a gap or shortfall between the two, solutions are calculated with rates of return, contribution amounts and number of working years that produce an account value at retirement equal to the amount needed to produce the target income stream.

One embodiment of the invention solves for three solutions; The Maximum Return Solution, which maximizes rate of return first, The Maximum Deferral Solution, which maximizes the amount of contributions first and The Maximum Years to Work Solution, which maximizes the amount of time to work.

Choice 1: the Maximum Return Solution

This Maximum Return Solution solves the variables in a hierarchy of 1) expected return up to a predetermined maximum limit, 2) additional investment (up to qualified plan or retirement account limits if that vehicle is being used) and 3) additional years the investor will have to work. There are three series of columns that interpolate the solutions for these requirements. They are the Increase Rate Table 1 the Increase Payment Table 1 and the Increase Years Table 1.

This Increase Rate Table 1 determines the maximum return that is required to close the gap between the future value at retirement of the investor's current strategy and the present value of the retirement payments for the nearest attainable goal. Two columns, the “Future Value Accumulation” column and the “Present Value Distribution” column and the rate that is being interpolated are used to find a solution.

The Future Value Accumulation column contains cells that calculate the future value of the account balance each year. The value that corresponds to the retirement date is chosen as the account value at retirement. Each cell's formula uses the rate being interpolated as the interest rate, number of pay-periods, payments from the Deferrals, Match and Loan Payments columns and the value of the previous period is the present value. The total FV of the outside assets is added to this value. As an example of a Future Value Accumulation formula is:

=FV(AX3/Pay_Periods,Pay_Periods,−(AC13+AE13+GA13)/Pay_Periods,-AV12)+EU13

Where AX3 is the value being interpolated and EU13 is the total value of outside assets.

Note that these cells calculate the future value as of the end of the year. The beginning balance is as of the last day of the previous period, the contributions are made each payday during the year, interest is compounded each payday. The value that is chosen as the account value at retirement uses the salary that begins the first day of the year (in this case year 17), so the retirement income needed for the next year is the value that corresponds to the year after retirement (in this case year 18).

The Present Value Distribution column contains cells that calculate the present value of each year of inflation adjusted retirement income beginning with the first year of retirement and the final year. Each calculation uses the rate being interpolated for the discount rate, monthly pay periods, the amount of retirement benefits for the chosen goal in the Goal 100 Income or Other Income columns and the subsequent year's beginning value as it's future value. The value for the final year of payments corresponds to the final year of the column. The value that corresponds with the first year of retirement is the amount required at retirement to pay the income stream in either Goal 100 Income or Other Income until the final year. An example of a Present Value Distribution formula is:

=IF(Years_in_Ret+Working_Years+1=AI13,B113,

PV(IF(AX3-AJ205<Guar_ROR,Guar_ROR/12,(AX3-AJ205)/12),12,

-IF(Pct_Goal_{—}100>=Ent_Other_Goal,AL13/12,AN13/12),-AW14))

The “IF(Years_in_Ret . . . )” statement places the ending estate value in the year payments will end. AJ205 is a reduction in rate of return to compensate for a more conservative retirement portfolio. The “IF(AX3 . . . )” statement tests the reduced retirement rate to determine if it is less than the Guaranteed Rate, which will be chosen if it is. The “IF(Pct_Goal_{—}100 . . . )” statement chooses whether to use the retirement income for the 100% Goal or the Other Goal.

The present value at retirement of the estimated cash flows in the Present Value distribution column must be equivalent to the future value at retirement in the Future Value Accumulation column in order to have enough money to pay the chosen goal's retirement income until the final year. As the rate increases, the future value at retirement increases because the interpolated rate is being used as an interest rate and the present value at retirement decreases as it is used as a discount rate. The rate of return that makes the present value and future value equivalent is the maximum required return for the first choice.

A macro interpolates interest/discount rate beginning with an initial increment of 10% which increases by increments of this value until the future value at retirement target value equals or exceeds the present value. At that point, one-half of the initial increment is added to the preceding value until the future value exceeds the present value. Then one-tenth of the initial increment is added to the preceding value until the future value exceeds the present value. The iteration process continues to compare the future target value to the present value until the two values are equivalent and a rate, which is accurate to one one-hundredth of a percent (0.0001), is attained.

The maximum allowable rates of return and contributions that can be suggested are determined by comparing these values to the maximum allowable values in the Plan Data. The limitation on suggested rates of return is the return of the riskiest suggested portfolio. Federal and plan guidelines limit contributions to various classes of employees. The lesser is entered as the “Required Rate of Return 1” for the first solution.

As an alternative embodiment, another maximum rate can be used for Non-participants as it would not be desirable to expose unsophisticated investors to a high level of risk with which they would not be comfortable.

The Maximum Rate of Return tested against its limits using the following formula:

=IF(AND(Contrib_Pct=0,B180>Max_ROR),Max_Non_part_Return,

IF(B180<=Exp_ROR,Exp_ROR,

IF(AND(Exp_ROR<B180,B180<=C444),B180,C444)))

Where the first IF statement checks for non-participants, then enters the maximum return for non-participants. The second IF statement determines if the Increase Rate of Return is less than the current Expected Rate of Return. If it is, the Expected Rate is used. The last IF statement determines whether the Increase Rate is greater than the Expected rate, but less than the maximum suggested portfolio rate, if it is, the Increase Rate is used. Lastly, if the Increase Rate is greater than the maximum suggested portfolio rate, the maximum suggested portfolio rate is used.

Returning to FIG. 2, a line of text 120 tells the participant how he should reallocate his portfolio in order to earn the required rate of return for this goal.

Next, the “Increase Payment Choice 1” table determines the maximum additional amount of contribution that is needed to close any remaining gap left if the required rate of return is less than the maximum rate. Three columns, the “Max Contrib”, FV Accumulation” and the “PV Distribution” are used to determine the maximum required deferral.

The Max Contrib column calculates the inflation-adjusted contributions for each working year using the value being interpolated by multiplying the value of each preceding year by the estimated inflation rate. This is the same formula used in the Salary column in the Accumulation Period table.

The FV Accumulation column calculates the future account values for each working year using the Increase Rate of Return number of pay periods, its corresponding year's payment in and the previous year's ending value as the present value. The future value at retirement is the value in that corresponds to the number of working years in the Years column. An example of a FV Accumulation formula is

=FV(Increase_ROR/Pay_Periods,Pay_Periods,−(BA13+GA13)/Pay_Periods,-BB12)

Where outstanding loan payments (column GA) are added to the Max Contrib in this formula because they are not part of a permanent contribution, but need to be included in the FV for each year.

The PV Distribution column determines the present value at retirement for the chosen goal (Goal 100 or Other Goal) using the Increase Rate of Return, twelve (monthly) payment periods, the required retirement payments for the goal, and the subsequent year's beginning value as its future value. As in the previous present value columns, the ending value in the final year is either zero or an amount to be left in the estate. An example of a FV Accumulation formula is:

=IF(Years_in_Ret+Working_Years+1=AI13,B113,

PV(IF((Increase_ROR-AJ205)<Guar_ROR,Guar_ROR/12,(Increase_ROR-AJ205)/ 12),12,

-IF(Pct_Goal_{—}100>=Ent_Other_Goal,AL13/12,AN13/12),−BC14))

Where the “IF(Years_in_Ret . . . )” statement places the ending estate value in the year payments will end. AJ205 is a reduction in rate of return to compensate for a more conservative retirement portfolio. The “IF(Increase_ROR . . . )” statement tests the reduced retirement rate to determine if it is less than the Guaranteed Rate, which will be chosen if it is. The “IF(Pct_Goal 100 . . . )” statement chooses whether to use the retirement income for the 100% Goal or the Other Goal.

Note that the present value at retirement can not be used because the rate of return that was interpolated could be greater than the maximum allowable return for non participants or the maximum portfolio return. This higher return would understate the present value at retirement.

The macro that interpolates the maximum required contribution begins with an initial increment of $10,000, then increases in increments of $10,000 until the future value at retirement exceeds the present value at retirement. At that point, one-half of the initial increment ($5,000) is added to the preceding value until the future value exceeds the present value. Then one one-tenth of initial increment ($1,000) is added to the preceding value until the future value exceeds the present value. This iteration process continues to compare the future value and the present value until they are equivalent and the iterated value is accurate to one dollar. At that point, the iterated value is the “maximum required contribution 1.”

Because the “maximum required contribution 1” includes potential employer contributions and the deferral percentage must be a whole number, the “deferral percentage needed” for the solution is determined by the Contribution Needed Table.

A formula enters the non participant default contribution for non participants or chooses the Required Contribution Percentage that corresponds to the “Total Dollar Contribution.” The formula is:

=IF(B229<B223,Cont_Non_Part,HLOOKUP(C229,B223:AA225,3))

The Deferral % Needed is chosen from a table that sequentially calculates the dollar values using the possible deferral and match percentages. The deferral percentage that corresponds to the closest of these values is chosen as the required deferral percentage for Choice 1 after being tested for deferral limits from the Plan Data.

A line of text 121 in FIG. 2, tells the participant the deferral percentage that is required to attain this goal. If it is the same as his current deferral percentage, the message says to “maintain current deferral of x%”.

Lastly, the Increase Years table, determines the number of additional years to work if the Required Rate of Return and Increase Contributions are at their maximum limits and a gap still remains between the value at retirement and the required amount at retirement after using the increased deferral amount (salary x increase deferral percentage). As the maximum contribution in the Increase Payment Choice 1 table. Within this table are columns that determine the earliest year the participant could retire while meeting his goal. Although complicated, this is necessary because the amount of increase or decrease in Social Security or Defined Benefit plan payments that are later or earlier than normal changes the present value of the retirement payments for each year.

The concepts in this table are similar to the matching of present value retirement income streams with future value accumulation streams except that each year has a column that calculates the present value for various retirement ages. This is because Social Security provides for different benefit starting ages between 65 and 70 each with differing amounts of income. The present values for each potential year of retirement are compared with the future value of the accumulation of the account using the suggested return and deferral percentage. The first year with the lowest present value/future value is the one selected as the earliest year to retire.

When the earliest possible retirement year is chosen by the Increase Years table, a dialogue line 122 (FIG. 2) tells the number of years he will have to continue to work past normal retirement. (In the interest of preserving open space on the report, this line is left blank unless a value greater than working years is calculated.)

Choice 2: the Maximum Contribution Solution

The Maximum Contribution Solution solves the three variables in the hierarchy of additional investment (up to qualified plan or retirement account limits if that vehicle is being used), required return up to the maximum suggested portfolio limit, then the number of additional years the investor will have to work. There are three series of tables that interpolate the solutions for these requirements. They are the Increase Payment 2 table, the Increase Rate 2 Table, and the Increase Years 2 table.

The Increase Payment 2 table, determines the maximum additional amount of contribution that is needed to close the gap between the account value at retirement and the closest goal at retirement from the Distribution Period table. The “Payment” and FV Accumulation” columns and the payment amount to be interpolated are used to determine the maximum required contribution.

The Payment column calculates the future value contributions for each year beginning with an initial contribution value by increasing it each year by the estimated inflation rate. The FV Accumulation column calculates the future account values for each year using the expected rate of return, number of pay periods per year, corresponding contributions for each year in and the previous year's ending value as the present value. An example of a FV Accumulation column calculation is:

=FV(Exp_ROR/Pay_Periods,Pay_Periods,−(CF13+GA13)/Pay_Periods,-CG12)

Where the values in column CF are the payment stream, the values in CG are the previous year's ending value and the loan repayments are in column (GA). These are added to the calculations because they are temporary contributions.

The future value at retirement is the value in the FV Accumulation column that corresponds to the number of working years. The Choose Goal value is Goal 100 Income if the sum of the projected Social Security benefits, plan benefits and income from outside investments, divided by the projected ending salary is greater than or equal to the Other Goal. The value is Other Income if the sum of the projected Social Security benefits, plan benefits and income from outside investments, divided by the projected ending salary is less than the Other Goal.

A macro that interpolates the maximum required contribution begins with an initial increment of $10,000, with additional increments of $10,000 until the future value at retirement exceeds the chosen goal At that point, one-half of the initial increment ($5,000) is added to the preceding value until the future value exceeds the chosen value. Then one one-tenth of the initial increment ($1,000) is added to the preceding value until the future value exceeds the chosen value. The iteration process continues to compare the future value at retirement and the chosen value until the two values are equivalent and the interpolated value is accurate to one. At that point, the interpolated value is the “total required contribution 2.”

As in “total required contribution 1”, “total required contribution 2” is used to determine the required deferral percentage. This is done in the same manner as for total required contribution 1 above.

The Increase Rate Choice 2, determines the maximum rate of return that is needed to close any gap remaining between the future value at retirement using the Increased Deferral Amount and the amount that is required at retirement for the goal. Three columns, the “Payment” column, the “Future Value Accumulation” column, the “Present Value Distribution” column, and the rate that is being interpolated are used to find the solution.

The Payment column contains cells that calculate the inflation-adjusted contribution for each year beginning with the increased deferral amount which is entered into the first cell. Each year's value thereafter is increased by the inflation estimate and additional pay increases as described in the Accumulation Period table.

The FV Accumulation column contains cells that calculate the account balance each year in the same manner described for calculating future account values in Increase Rate Choice 1 table above. It uses the rate being interpolated for the interest rate, number of pay periods, corresponding contributions from the Payment column and the ending value of the previous period for the present value. An example of a FV Accumulation column calculation is:

=FV(CN3/Pay_Periods,Pay_Periods,−(CK13+GA13)/Pay_Periods,-CL12)

Where CN3 is the rate being interpolated, the values in CK are the payments and the values in CL are the previous year's ending value. The loan repayments are in column (GA). These are added to the calculations because they are temporary contributions.

The Present Value Distribution column contains cells that calculate the present value of each year of inflation-adjusted retirement income from the final year to the retirement date. Each cell uses the rate being interpolated as the discount rate, monthly pay periods, the amount of retirement benefits to be provided for the chosen goal and the subsequent year's beginning value as it's future value. An example of a PV Distribution column calculation is:

=IF(Years_in_Ret+Working_Years+1=AI14,B113,

PV(IF((CN3−AJ205)<Guar_ROR,Guar_ROR/12,(CN3-AJ205)/12),12,

-IF(Pct_Goal_{—}100>=Ent_Other_Goal,AL14/12,AN14/12),−CM15))

Where the “IF(Years_in_Ret . . . )” statement places the ending estate value in the year payments will end. AJ205 is a reduction in rate of return to compensate for a more conservative retirement portfolio. The “IF(AX3 . . . )” statement tests the reduced retirement rate to determine if it is less than the Guaranteed Rate, which will be chosen if it is. The “IF(Pct_Goal_{—}100 . . . )” statement chooses whether to use the retirement income for the 100% Goal or the Other Goal.

The account value at retirement is chosen from the FV Accumulation column as the value that corresponds to the number of working years. This value must be equivalent to the value in the first year of retirement in order to have enough money to pay the retirement benefits, either 100% Goal or the Other Goal, until the final year. As the rate being interpolated increases, the future value at retirement increases as it is being used as an interest rate and the value at retirement decreases as it is used as a discount rate. After being interpolated to four decimal places, the rate being interpolated is the “maximum required return 2.”

A macro that interpolates the interest/discount rate begins with an initial increment of 10% and increases by increments of this value until the future value at retirement exceeds or equals the present value. At that point, one-half of the initial increment is added to the preceding value until the future value exceeds the present value. Then one-tenth, of the initial increment is added to the preceding value until the future value exceeds the present value. The iteration process continues to compare the future value to the present value until the two values are equivalent and a rate, which is accurate to one one-hundredth of a percent (0.0001), is attained.

This “maximum required rate” is compared to the maximum non-participant return or the maximum suggested portfolio return. The lesser is entered as the “Required Rate of Return 2” for the second solution.

A line of text 124 in the Report, FIG. 2, tells the participant the Required Rate of Return he must earn to attain the second goal. If it is the same as the expected rate of return, the message says to “maintain” the current investment allocation of x%.

Lastly, the Increase Years 2 table determines the number of additional years to work if the Increase Deferral Amount 2 and Required Rate of Return 2 are at their maximum limits and a shortfall remains between the projected account value at retirement and the goal now calculated by using the required rate in the Increase Rte Choice 2 table.

The table works in exactly the same manner as described for the Increase Years Choice 1.

When the earliest possible retirement age is chosen by the Increase Years 2 table, a dialogue line 125 in the Report, FIG. 2, tells the user the number of additional years he will have to continue to work. (In the interest of preserving open space on the report, this line is left blank unless a value greater than working years is calculated.) The Increase Time table, determines how many years will have to be worked without changing the current strategy, i.e. maintaining current contributions and expected return. The table is the same as described in Increase Years Choice 1 table, except there are additional columns for ages 62 through 64. These are present here and not in the two previous Increase Years tables because they determine years beyond normal retirement that the participant might have to work and the earliest normal retirement age is currently 65. The Increase Time table must calculate early retirement for those with estimated income replacements in excess of 100% of their ending salary.

There is additional dialogue in the Report that suggests that if the investor cannot increase his contributions to the required amount, reductions in take home pay for increases of 2% and 4% are given.

The investor can choose between the two solutions that will enable him to meet the nearest goal at his expected retirement age or continue on his current course and have to work past normal retirement age. Typically, additional contributions will be less in the first solution, but require more risk. Risk will typically be lower in the second solution, but require greater contributions. Either solution will put the investor on track to attain his next goal.

Personalized Investment Suggestions

Asset allocation suggestions are provided by illustrating allocation models 129, 130 with their respective expected rates of return 131, 132 that approximate the required rate in each solution 121 or 124. If the required return of either solution, is equivalent to the investor's current portfolio's expected return, a preferred embodiment of the invention provides a suggested optimized portfolio that provides a similar expected return as the existing account portfolio, but with less risk. The suggested allocations 129 and 130 are selected from a series of previously determined optimized portfolios.

These portfolios can list either specific investments (e.g., mutual funds by name) or generic asset classes (e.g. small cap, large cap-value, etc). Under current Department of Labor guidelines, naming the funds in which to invest and the amounts constitutes investment advice, while naming generic asset classes and their weightings would be considered investment education. Education would also require that the static portfolio models be used in other enrollment material. The Plan Data has an input that chooses either investment advice portfolios designated by an “A” or educational portfolios, designated by an “E”.

Suggested Portfolio Chart, selects the predetermined portfolios to be included in the suggested portfolio charts 129 and 130 respectively. Text 133 and 134 (FIG. 2) tells the investor the range of single year returns he can expect and the relative riskiness of the suggested portfolio compared to his existing account allocation. Text 135 tells the investor how to contact the facilities that are available to change his asset allocation.

The Third Step: Monitoring Actual Returns

Step 3 enables the investor to monitor his account's progress toward his goal by measuring his actual return for each reporting period as well as longer-term periods. By comparing his actual return to his expected return, he can determine if his strategy is on track each period to attain his goal.

Two graphs illustrate these returns. The “Periodic Returns” chart 136 is a line graph that illustrates the participant's actual periodic account returns and the volatility of those returns. It shows the time-weighted return each period for up to twenty periods (quarterly, semi-annually, or annually). Text that accompanies this chart tells the average return and range of returns his portfolio has produced over four quarters, two semi-annual periods or annually. The “Your Account's Returns” chart 137 is a bar graph that illustrates longer-term compounded returns over customary periods that can be compared to reported returns for his underlying investments.

The Periodic Chart Returns table calculates the time-weighted periodic returns 138 used in the chart 136. The calculations use the number of deposits per period (number of pay periods divided by the report frequency, payment per period, beginning balance less loan withdrawals, and ending balance. This gives the average rate earned on each deposit during the deposit. This rate is multiplied by the number of deposits during the period to arrive at the rate per period. An example of a periodic rate formula is:

RATE((Pay_Periods/C101),B107/(Pay_Periods/C101),B105+Pivot!B10,−B106)*(Pay_Periods/C101)

Where C101 is the Report Frequency. Pivot!B10 is the cell that contains the loan withdrawal amount.

The Rolling Annual Returns column calculates the return for any number of periods (four quarters or two semi-annual periods) as a simple average of the individual returns for each rolling period.

The Average Return in any four quarters (two semi-annual periods), which appears at 141 is the average of four quarter (two semi-annual) groupings of the quarterly returns row. The lowest four quarter (two semi-annual periods) return in the Rolling Average Returns row, which appears at 142 and the highest four quarter (two semi-annual periods) return, which appears at 143.

The “Your Account's Returns” bar chart illustration 137 shows the investor the time-weighted latest period, year-to-date, one-year, three year, five-year, ten-year, and since first deposit (data) returns for his account. The actual returns for those periods and the variances in returns are shown by the bars 145.

The text 146 tells how the longest period return 147 compares with the existing account's expected return 148 to affirm whether or not his investments are measuring up to the assumptions in his investment strategy. If it is greater, he can either stay the course, or reallocate his investments to assume less risk. If it is less, he can identify under-performing assets and make mid course corrections.

The tables in the Compound Returns Chart table, calculate data that is displayed in chart 137. It begins by calculating return relatives in the Return Relatives table for the periodic returns in the Periodic Return row. The return relative is simply “1” or “100%” plus the periodic return. Return relatives are used in calculations to eliminate negative values. The compounded rates for quarterly, semi-annual or annual periods respectfully are calculated in columns using the following formula:

Gₚ=[(1+R₁)(1+R₂)(1+Rₙ)]^{1/n}−1

Where:

Gp=geometric mean of the portfolio

R=return for each period

n=number of returns

Outside Investments

Outside investments are not analyzed in terms of expected return and risk or past performance by the invention, but the retirement income they could generate and their future values are calculated as part of the total retirement income available to the participant. The investment strategy suggestions in, Choice 1 and Choice 2 would not be accurate if the participant's other retirement income producing assets were not considered, because suggestions with overly risky investment portfolio or excessive contributions or both would be suggested to make up for the perceived gap in the account value at retirement and the required account value at retirement to meet the goal.

The Outside Investments table, calculates the value at retirement and the income that could be provided from each of five outside investments based on participant inputs. Outside investments are those that are accumulated through systematic savings plans and can be liquidated to provide retirement income, typically IRAs, spouse's 401(k)s, stock option plans and other savings vehicles.

These inputs can be entered into the calculator two ways; directly into the Participant Input Variables table, of the calculator or through an interactive web site. For participants receiving printed reports through their employer, inputs are saved until the next time printed reports are provided, so that they reflect the best available information.

The Outside Investments tables function exactly the same as outlined for the Retirement Income From Plan.

The Loan Repayment Table, calculates the plan loan repayments to be made each year. The table calculates repayments for up to four consecutive outstanding plan loans. It is important to account for repayment of plan loans because these additional payments contribute to the growth of the account and its value at retirement. The participant enters the total number of payments left to be paid and the amount of each payment. The “Number of Payments” column uses the total number of payments and number of pay periods to calculate the number of payments to be made in each year. if the participant has not entered the actual number of loan payments left, the default value for the number of outstanding loan payments is entered.

The first test is whether the number of payments is greater than the pay periods in one year. The second test is whether the number of payments less one year is greater than zero, but less than one year. If neither of these tests is true, the value is less than one year and is entered in year 1.

The “Amount” column calculates the total amount of loan payments for each year. It uses the loan payment entered by the participant or calculates it from data provided by the administrator. An example of an Amount column calculation is:

=IF(J202>0,J202,HLOOKUP(B8,B102:U108,7)/(Pay_Periods/C101))*FS4

Where J202 is the amount entered by the participant. If the participant has not entered a value in J202, the lookup function selects the last loan payment from loan payment data in the Historical Cash Flow Data, which is divided by the number of pay periods in the period (number of annual pay periods divided by the report period). The loan payment is multiplied by the number of outstanding payments, which can be the value input by the participant or the default number of payments from the Plan Data.

The payments for all loans 1 through 4 are totaled for each. These values are added to deferral amounts each year in all calculations that consider deferrals.

Participant Report Without Historical Data

The Participant Report Without Historical Data, FIGS. 3a-b is provided to contributing participants who are in plans that can not supply historical account data. It differs from the Historical Participant Report in that it does not determine past performance because it doesn't have access to historical account data. It requires only Plan Data, current Census Data from the employer and account Asset Allocation Data from the plan's record keeper.

Like the Historical Participant Report, FIG. 2, the Participant Report Without Historical Data, FIG. 3, tells the participant the key factors that will determine his retirement income from the plan: current value of his account 300, contribution percentage 31, match percentage 302 and normal retirement age 303. It illustrates retirement income projections and quantifies the values of the two goals in the Retirement Income illustration 304. Text at 305 details the information displayed in 304.

It also illustrates the asset allocation for the New Contributions 306 and the Existing Account 307 and tells the expected return and range of returns for each allocation 308 and 309 respectively. To set the stage for any necessary changes in strategy, the participant is told the amounts he should have in his account as of the date of the report if he was on track to attain the other goal 310 or the 100% goal 311. This is used in place of the “Retirement Track” illustration 109 and the values come from the same calculations used in that illustration.

The investment advice section provides the same three solutions 312, 313, 314 some intermediate steps 315 to the required contribution, and suggested investment allocation portfolios 316 as in FIG. 2.

Because no historical data is available for this report, illustrations of actual periodic 136 or long-term returns 137 are not created, nor are comparisons between expected returns and actual returns 146.

The remainder of the report shows the benefits and advantages of choosing “Choice 1” to attain the next retirement goal. The first solution is chosen because it usually requires less out-of-pocket contribution. The report illustrates the advantages of saving with pre-tax dollars 317 through a paycheck comparison illustration 318, tax deferred investment gains 319, the convenience of payroll deduction 320, easy access to a variety of investments 321, and the value of the employer match 322.

The “Paycheck Comparison” 318 mathematically illustrates the tax saving that should occur on each of the participant's pay checks 323 and on an annual basis 324 if he contributed the required amount in the first solution 325. Both federal and state, tax withholding schedules are used to assure accuracy of estimated withholding taxes 326. The paycheck comparison 318 is a common illustration in the art which shows participants the payroll tax saving process. The participant's gross salary is at the top to two columns with the amount being contributed to the plan 325 being deducted before tax resulting in a lower taxable income. Withholding taxes 326 are calculated, then the after tax contribution is deducted resulting in net take home pay The difference in take home pay 323, 324 for pre tax and after tax basis savings is compared to show the advantages of pre-tax saving. The invention uses withholding tax tables which are distributed by governmental agencies to calculate both federal and state withholding tax.

The advantage of deferring investment gains is shown as a line graph 327. The calculations start with the same amount of investment 328 except that a reduction in annual ending balances is made for taxes paid in the investor's combined tax bracket 329, which is calculated during the paycheck comparison below.

The “Pre-Tax vs. After Tax Accumulation Chart” table acquires the data that is used to generate the chart at 327. The Pre-tax column uses the future values of the deferrals in “Choice 1 Accumulation Table” above. Various tables are used to calculate the future values each year using the inflation adjusted salary, the required deferral percentage, return and number of working years for Choice 1 on a pre-tax and after-tax basis. After-tax values are accounted for by multiplying the required rate of return and deferral amount by the reciprocal of the participant's marginal tax bracket. The values for each year are displayed in the chart for the years remaining in the accumulation period. The Pre-tax vs. After-tax chart 327 is an illustration that shows the account balance for each year until retirement using future value formulas with the required return and contribution and pay periods from Choice 1. The after-tax balances are calculated using an interest rate and contribution that have been discounted by the participant's marginal tax bracket.

The columns in the “Choice 1 Accumulation Table”, calculate the future pretax and after tax account values using the required deferral, return and working years in “Choice 1”. The distribution account balances for Choice 1 use future value calculations with Choice 1's required rate of return less a factor to illustrate a more conservative retirement portfolio, the amount required from the 401(k) to replace the difference between the goal' income each year and Social Security and pension benefits, monthly payment periods, and the previous year's ending balance as the beginning balance. The Current Strategy uses the expected return less a the same factor to illustrate a more conservative retirement portfolio, monthly payment periods, inflation adjusted payments required from the plan, and the previous year's ending balance as the beginning balance.

The “Salary” column calculates the inflation adjusted salary/retirement income for each year. Note that these are not necessarily the same as in the Accumulation Period table discussed above because the merit pay increases may continue longer if the participant's required working years in Choice 1 are greater than working years until normal retirement age. The remainder of the table is similar in form and function as the Accumulation Period table with the addition of the After tax column as described above.

The Income Tax Calculator calculates the Federal Withholding Tax. The gross salary is entered for each of the seven tax withholding scenarios to be considered. The pre-tax deductions are subtracted from the gross salary, resulting in taxable income. Total Federal exemptions are based on the filing status and number of exemptions from the Census Data multiplied by the values for each exemption leaving taxable income. The tax withholding amount for each scenario is calculated for all filing statuses using the tax tables.

State Withholding Tables are Constructed in the Same Manner as the Federal Tables.

The Choice 1 vs Current Strategy table determines the account values that are used in the illustration 334. The “Choice 1” column enters values that are illustrated in the chart for both the accumulation and distribution periods using the required return, deferral percentage and working years for Choice 1. The Current column uses the expected return, current deferral percentage and normal retirement age during the accumulation and distribution periods. The object is to illustrate the amount of additional income that could be available by following the advice in Choice 1 as well as the additional number of years that income would last. Text at 335 tells the participant the number of years the income using Choice 1 could last and the number of years he might expect income to last from his current strategy. It also totals the estimated additional income for those additional years which is included in the text.

The Non-participant Report

The Non-Participant Report, FIGS. 4a-b, is provided to non-investors in all plans. It uses only Plan Data and Census Data to establish the first saving strategy for those who are not contributing to the plan. It is essentially the same as the “Participant Report Without Historical Information”, FIG. 3, except it does not include asset allocation information 306, 307, 308 and 309. The investment suggestions, “Choice 1” and “Choice 2”, as well as the suggested investment allocation charts are provided and calculated as above. Also included are the “Paycheck Comparison” 317, 318, Pre-tax illustration and text 327, 319, Convenience of Payroll deduction 320, Access to Investments 321, and Matching Contributions 322.

The “Choice 1 vs. Current strategy illustration 334 and text 335 are not provided because there is no current strategy. Two new illustrations, “(Plan) vs. After-Tax Savings” and “The High Cost of Waiting”, are designed to encourage non participants to take immediate action.

The (Plan) vs. Personal Savings Chart shows the combined advantages of saving with the plan as opposed to the same strategy using after-tax saving vehicles. The annual account values, assuming the required return and deferral percentage of Choice 1, are calculated for both the accumulation and distribution periods on a pre-tax and after-tax basis. Color codes in the legend box identify the two series.

The calculated data for chart is in the Plan vs. Personal Savings Chart table. Data series for this chart are calculated the same way as the Choice 1 vs. Current Strategy chart except after tax values are calculated instead of the current strategy values. This table combines data which has been calculated elsewhere and is presented by the illustration.

The Additional Years of Income table, determines the additional income that would be paid from the Plan after payments from personal savings have ceased. The number of years of payments for the pretax and after tax income streams are counted and the income stream for the additional years is copied into a column which is totaled to determine the additional income from the plan.

The High Cost of Waiting Chart 401 illustrates the potential amount the participant's account balance would be reduced by starting his saving plan at a later date. The High Cost of Waiting chart shows the cost of waiting five and ten years to start saving instead of the present. The bars on the chart illustrate the comparative differences in ending values at retirement age. Columns of future value calculations again use the required return, inflation adjusted contributions, and working years from Choice 1. The five year future value starts with the inflation adjusted salary five years from the report date and the ten year future account value starts with the inflation adjusted salary in ten years. The ending account balances are subtracted from each other to tell the participant the amounts he could be foregoing 410 and 411. The amount of forgone matching contributions are the sums of the first five 412 and ten years 413 of matching contributions.

The High Cost of Waiting Chart table calculates data for the chart. It contains the Years column, Now column, Five Years column and Ten Years column.

The Now column calculates the future account values beginning at the time of the report. Each year's calculation uses the required return and deferral percentage for Choice 1, number of pay periods corresponding inflation adjusted deferrals and match , and the previous year's ending value (or zero in the first year) as the beginning value. An example of a Now column calculation is:

FV(Increase_ROR/Pay_Periods,Pay_Periods,−(AV97+AX97)/Pay_Periods,0)

Where the values in AV and AX are the deferral and match payments respectfully. The Five Years column uses the same formula, but begins in the sixth year using the corresponding deferral and match and zero as the beginning value. The Ten Year column formulae are again the same, but begin in the eleventh year. This is important because these calculations consider the inflation adjusted salary and contribution amounts beginning in the sixth and eleventh years.

The text 408 advises the investor that if he began making contributions in the amount of the value at 409 to his account today, those contributions could be worth the value at 410 more compared to starting five years from now and the value at 411 more compared to starting ten years from now. Lastly, it tells the amount of employer contributions that would be would loose over five years 412 and ten years 413 as a result of non-participation.

The five-year amount 410 is the difference between the ending value at retirement of the Five year column and the Now column and the ten-year amount 411 is the difference between the ending value at retirement of the Ten year column and the Now column. The amounts of employer match waived for the first five years at 410 and ten years at 411 are the sums of the first five and ten years respectively of the match future values calculated above for Choice 1.

The Merge Routine macro controls the operation of the entire calculator. It first copies the first row of Census Data and pastes it into the Calculations sheet. Next it uses the Social Security number to query the database to access the data to be used for the participant. The Calculation sheet uses the data to update its calculations throughout the sheet.

The Worksheet Calculate subroutine controls the operation of the interpolation calculators. When the interpolations are finished, the Calculations page recalculates The Pivot tables on the Pivot sheet that create the graphical illustrations refresh using the newly calculated data from Calculations. When they refresh, all the charts in all of the reports change.

All of the reports, Participant, Non Participant and Participant Without Data recalculate and are ready to be presented. Lastly the correct report is chosen and printed or sent to the user's browser to be viewed.

At this point, the viewer in an interactive version could return to the Participant Input Variables sheet to enter more data or change some assumptions. Any of the three reports can be delivered in printed form, viewed or printed from a stand alone program on a diskette or web site.

Lastly, the preferred embodiment of the invention gathers specific data for each participant such as his projected income replacement, expected rate of return, risk, diversification, advice given, age, years in the plan and much more as is contained in the Employer Report Data. This data is used to prepare detailed reports that then plan sponsor, broker, consultant or compliance officer can use to identify areas of success or ones that need to be improved to either enhance the benefits provided by the plan or ward off potential compliance problems.

FIG. 5 is a schematic of the processes that are used to generate the text and illustrations in the Participant Report With Historical Data, FIG. 2.

The top of the schematic illustrates the various data that are required to produce a report. These data are gathered by the Retirement Analyst from employers, plan administrators, consultants and other parties to the plan. Apart from Participant Input Variables, which is part of an interactive embodiment, participants do not have to make any assumptions or enter any data to receive a fully serviceable report.

Plan Data 500 is default data that is universal to all participants in the plan, which is supplied by the plan sponsor or administrator. This includes, but is not limited to employer name, plan name, type of plan, report frequency, date on the report, match formula and limitations, highly compensated employee limits, pay periods, minimum and maximum percentage contribution, maximum dollar contribution, normal retirement age, maximum retirement age, age retirement income will stop, inflation estimate, additional inflation to be illustrated, maximum non-participant expected return, guaranteed or stable value account rate, contribution for non-participants, number of loan payments, reduction in expected return during retirement, investment provider name, customer service phone number and web site address, and whether the program will provide advice or education.

Census Data 501 is basic personal information about individual participants, which is supplied by the plan sponsor or administrator. This contains Social Security number, name, date of birth, date of hire, salary, deferral percentage, federal and state filing status and number of exemptions, the state in which he is filing, the name of the workplace location, Spanish report yes or no, and mailing address.

Participant Input Variables Data 502 is data that is available for participants to change in a interactive version. This contains estimate of ending career salary, annual pay increases in excess in excess of inflation, ending account value to be left to his estate, inflation estimate, age retirement income will stop, new contribution percent, new other goal, maximum retirement age, reduction in expected return during retirement and additional income from employment. In addition to these changes in default settings, information about outstanding plan loans and outside investments can be entered for consideration, but not analysis. This contains loan payment and number of payments to pay for up to four loans and balance, expected return, deposit per period, number of deposits per year, whether deposits are indexed to inflation, and whether or not they are taxable, for up to five additional investments.

Historical Cash Flow Data 503 mirrors key data that is included on the participant's account statements. This includes net employee contributions, employee ending balance, net employer contributions, employer ending balance, loan withdrawals, loan payments, and beginning balance.

Asset Allocation Data 504 reflects the way both new money is invested in the plan according to the participant's investment selections and the percentage allocation of his existing account. This includes either the percentage allocation or dollars contributed to each investment option and the investment's asset class.

Suggested Portfolios 505 are the optimized portfolios that have been designed by the Retirement Analyst to deliver targeted rates of return with minimum expected risk. They range in expected returns from 6% through 14% and are chosen based upon the required return for the suggested investment strategy. The text and illustrations 106-116 as they appear in the Participant Report, FIG. 2, are along the left side of the schematic and the various calculation steps are located in the body.

The primary factors that determine the participant's retirement income are outlined in the report in 106. Data for the text is gathered from 500-503 and 517. In order to determine the participant's current position with reference to attaining a comfortable retirement, goals must be established as well as the estimated income that might be available from his current plan investment strategy and other sources of retirement income. The goals are based on current salary adjusted for inflation and the estimated retirement income from the current strategy is calculated using data from 500-503 and the expected return from his current investments 517.

The Accumulation Period table 518 uses the expected rate of return, inflation adjusted salary, current deferral percentage, match formula and current account balances to calculate the future account value at retirement.

When the future account value at retirement is known, the amount of inflation adjusted income can be determined using a table that interpolates that value. This concept runs through many other tables which interpolate values and works by matching the present value of the distribution stream with the future value of the accumulation period.

An income stream is calculated beginning with an initial value to be interpolated and increased each year by the inflation factor. A column that calculates the present value of that stream beginning with the year in which payments are scheduled to cease and discounting it by the participant's expected rate of return less a factor to adjust for a more conservative retirement portfolio. The macro Inc_Provided, explained in detail above, runs numerous calculations of the initial value each time testing whether the present value in the first year of retirement is less than the future value at retirement calculated in 118. When a value accurate to one dollar is obtained and the present value of the distribution stream is equivalent to the future account value at retirement, then there is enough money at retirement to service the retirement income is the assumptions hold throughout the retirement years.

With the income from the current strategy known, retirement income from Social Security and company pension plans is added to determine the total income from the current strategy and compare it with either of the established goals 107.

The account balance needed at retirement for each of the goals is calculated in the Distribution Table 520. This table calculates the required amount using columns of present value calculations as in 519 above each using the inflation adjusted ending salary less Social Security and pension benefits as the amount needed to be replaced by the plan (the other goal is a fraction of this amount), and the same discount rate and ending value as above. The value that corresponds to the first year of retirement is the amount needed at retirement for each goal.

The Retirement Track illustration 108 in FIG. 2. shows the present value of the two amounts required at retirement by further calculating the present values in (Present Value to Date table 521 using the contribution data from the Accumulation Period Table 518. This step calculated the present value to the date of the report. Because all of the previous calculations have been on an annual basis, the present values must be calculated according to the periods used in the Retirement Track, i.e. quarterly, semi-annually or annually. This is done in the Present Value By Period Table 522. When these are complete, the data is ready to display along with the actual account values for each of the periods that are included in the report from 103.

Text and graphs in the New Contributions and Existing Account 109 section of FIG. 2 are designed to illustrate the asset allocations for New Contributions and the Existing Account as well as develop expectations for rates of return and annual risk. The pie charts are based on data in 104, and the expected return 117 and the standard deviation of the two portfolios 123 are used in the text. Calculations for expected rate of return and standard deviation of a portfolio are well known in the art.

The investment advice section consists of two new investment choices and the consequences of maintaining the current strategy.

Choice 1 110 solves the basic future value equation, Rate×Payment×Time, in that order by determining the maximum rate that is required to close any gap between the values in account balance at retirement 518 and the amount needed at retirement 520. The Max Rate Table 524 uses interpolation as described above, to determine the rate that would close the gap, maintaining all other assumptions, so the two values would be equivalent. This maximum rate is tested to assure that it is within prescribed limits of the plan and investment manager.

If there is a gap remaining between the account value at retirement and the amount needed at retirement using the tested required return, the Maximum Contribution Table 525 calculates the maximum contribution that will close the remaining gap. Again interpolation comparing future values of accumulations and present values of distributions determines the maximum contribution value. The participant's portion of this dollar amount is determined and as above, this is tested for plan limits.

If there is a gap remaining between the account value at retirement and the amount needed at retirement using the tested deferral percentage, the Maximum Years Table 526 determines the extra number of years the participant will have to work. It does not use interpolation, but rather a series of present value columns for each retirement age because Social Security provides for different benefits at different ages. Each years' present value is compared to the future account values using the required return and contribution. The year that requires the lowest account balance is chosen as the earliest year to retire. Text 110 in FIG. 2 tells the participant the values for the three variables.

Choice 2 111 uses the same routine as described above to determine a second solution. This solution determines the Maximum Contribution first 527, then the Maximum Required Return 528, the Maximum Years 529. This alternative many times requires less investment risk, but more money and is better suited to risk averse participants.

The Working Years solution 112 uses the Max Years table 530 which is similar to 526 above to determine the number of years the participant must work if he maintains his current strategy.

Choice 1 110 and Choice 2 111 require minimum rates of return in order for each strategy to succeed. Portfolios 105 which have been optimized to provide an expected target rate of return with the least expected risk are provided in 113 and 114. The selection process is based on the required return for each Choice and selected from a table which contains the names and weights of the suggested investments. In an education embodiment of the invention, the weights and names of the asset classes are given.

The Quarterly Returns Chart 115 displays the calculated time weighted periodic (quarterly in most cases) returns. The Calculate Returns Table 531 uses mathematics well known in the art to calculate time weighted returns using deposits, withdrawals and beginning and ending balances for each of the periods. The chart 115 in FIG. 2 illustrates the volatility of the periodic returns and provides a trend line to enable the participant to evaluate the performance of his account. The Calculate Compounded Returns table 532 uses the periodic returns to calculate compounded returns for up to twenty periods. Again these calculations are will known in the art. The Compounded Returns Chart 116 provides a means for the participant to compare his actual long-term account performance with that of his expected account performance. This is a key factor in determining the success of an investment strategy.

The above description of the invention is intended to be illustrative and not limiting. Other embodiments of this invention will be obvious to those skilled in the art in view of the above disclosure. For example, although the invention has been described in terms of implementation in a spreadsheet, the functions and displays can also be performed by a software program written in a high-level language such as “C” or Basic. Such an implementation would not depart from the scope of the invention.

What is claimed is:

1. A computer-implemented method of allocating an individual's retirement contributions and assets for enhancing retirement income, the method comprising the steps of:
obtaining an investor's current and historical personal and account data;
determining an attainable retirement goal based on current salary;
calculating a likely retirement income based on the investor's current personal and account data and a calculated expected investment rate of return;
providing at least two alternative strategies for the investor's retirement contributions and assets to improve the likely retirement income to the attainable retirement income goal;
calculating and displaying periodic account balances and the present value of the attainable retirement income goal in a computer generated format, the format comprising a comparison between historical account values and the corresponding present values of the account balance required to reach the attainable retirement goal.

2. The method of claim 1, further comprising the step of periodically recalculating the likely retirement income based on actual performance of a selected strategy for the investor's retirement contributions and assets and determining changes to the selected strategy for the investor's retirement contributions and assets to improve the likelihood of reaching the attainable retirement income goal.

3. The method of claim 1, wherein the step of providing at least two alternative strategies for the investor's retirement contributions and assets comprises calculating a likely end of working career income.

4. The method of claim 3, wherein the attainable retirement income goal is less than the end of working career income.

5. The method of claim 3,wherein the attainable retirement income goal is at least the same as the end of working career income.

6. The method of claim 3, wherein the attainable retirement income goal is selected by the investor.

7. The method of claim 1, wherein the step of providing at least two alternative strategies for the investor's retirement contributions and assets comprises calculating a maximum return on investment required to reach the attainable retirement income goal, selecting from a plurality of suggested asset allocations to meet the maximum return on investment, and if no suggested asset allocation meets the maximum return on investment, calculating a maximum amount of periodic retirement contributions necessary to reach the attainable retirement income goal, and if the maximum amount of retirement contributions exceeds a predetermined limit, calculating a maximum number of years required to work before retirement.

8. The method of claim 1, wherein the step of providing at least two alternative strategies for the investor's retirement contributions and assets comprises calculating a maximum amount of periodic retirement contributions necessary to reach the attainable retirement income goal, and if the maximum amount of retirement contributions exceeds a predetermined limit, calculating a maximum return on investment required to reach the attainable retirement income goal, selecting from a plurality of suggested asset allocations to meet the maximum return on investment, and if no suggested asset allocation meets the maximum return on investment, calculating a maximum number of years required to work before retirement.

9. The method of claim 2, wherein the step of periodically recalculating occurs at least once a year.

10. The method of claim 1, wherein the step of calculating and displaying further comprises displaying a potential range of returns on current investments.

11. The method of claim 1, wherein the step of calculating and displaying comprises showing a calculated rate of return for the time periods comprising year-to-date, one year, three-year, five-year, ten-year, and since beginning of investments, and compares the calculated rate of return for the longest period with an expected rate of return.

12. The method of claim 1, wherein the step of calculating and displaying comprises showing a calculated quarterly percentage change in value of the investor's periodic account balances and showing a calculated trend line.

13. The method of claim 1, wherein the step of calculating and displaying comprises showing a calculated comparison of expected retirement income from pursuing a first suggested strategy with expected retirement income from the investor's existing strategy of non-participation in an employer's retirement plan.

14. The method of claim 1, wherein the step of calculating and displaying comprises showing a calculated comparison of expected retirement income from pursuing a first suggested strategy with expected retirement income from the investor's existing strategy.

15. The method of claim 1, wherein the step of calculating and displaying is performed periodically for each of a plurality of members of a participating retirement plan without input from the plurality of members.
